(19) United States
(12) Patent Application Publication
(10) Pub. No.: US 2010/0005932 A1
(43) Pub. Date: Jan. 14, 2010

(54) Spud wrench

(76) Inventors: Tyler V. Young, St. Louis, MO (US); Mickel Risko Smith, Florissant, MO (US)

Correspondence Address: MCDONALD HOPKINS LLC, 600 Superior Avenue, East, Suite 2100, CLEVELAND, OH, 44114-2653, US

(21) Appl. No.: 12/459,026

(22) Filed: Jun. 25, 2009

Related U.S. Application Data
(60) Provisional application No. 61/133,143, filed on Jun. 26, 2008.

(51) Int. Cl. B25B 13/50; B25B 13/06; B25B 23/16

(52) U.S. Cl. 81/124.2; 81/124.5; 81/124.6; 81/185.2

(57) ABSTRACT

The present invention is directed to a spud wrench and a spud wrench kit. The spud wrench may include a lever, a socket and an insert. The socket may include an aperture capable of receiving the lever within, wherein the socket may include an enlarged end. The insert may include an aperture in a first side and an opening in a second side, wherein the lever may be capable of insertion within the aperture of the first side. In addition, the socket may be capable of moving relative to the lever and the insert may be capable of moving relative to the socket. The spud wrench kit may further include a socket wrench, a case and inserts of various shapes and sizes and sockets of various shapes and sizes. The inserts and the sockets may be interchangeably used with the lever in numerous manners.

### CROSS-REFERENCE TO RELATED APPLICATION

This application claims benefit from U.S. Provisional Patent Application No. 61/133,143, entitled “Spud Wrench,” filed on Jun. 26, 2008, which is hereby incorporated in its entirety by reference.

### FIELD OF THE INVENTION

The present invention is generally related to a wrench and, more particularly to a spud wrench used for the installation and removal of plumbing fittings.

### BACKGROUND

It is well known in the art to utilize a wrench to aid in assembling and disassembling various plumbing fittings and fixtures. There are many different types of wrenches known in the art that may be utilized to install, remove, and tighten, for example, various types of plumbing fittings. One type of wrench used in the art is a spud wrench. The spud wrench was derived from the piece of piping found on older toilets or sinks called a “spud.” These older toilets frequently have a large pipe, or spud, which connects the tank to the bowl. The spud is held to the bowl and tank by extra-large hexagonal slip nuts. The spud wrench is used to tighten and to loosen the collar, bolts or other hardware holding the spud to the toilet or sink.

There are also numerous designs for spud wrenches that exist in the art. Spud wrenches may be used to install and remove the brass or chrome plated seal on a bathtub drain, a sink drain, or waste disposal drains, for example. Before or after the drain is in place, especially in drains such as bathtub drains, it is often difficult to reach the underside of the drain, in order to position a wrench to install or remove the spud or seal.

Therefore, a need exists in the art to provide an improved spud wrench apparatus that will accomplish the task usually performed by the use of two or more tools in combination. In addition, upon positioning the wrench in and/or on a spud, the wrench may come in close surface contact with all of the projections or structures in the spud.

### DESCRIPTION OF THE DRAWINGS

Objects and advantages together with the operation of the invention may be better understood by reference to the following detailed description taken in connection with the following illustrations, wherein:

FIG. 1 illustrates a perspective view of an embodiment of a spud wrench.

FIG. 2 illustrates a perspective view of the spud wrench of FIG. 1.

FIG. 3 illustrates another perspective view of the spud wrench of FIG. 1.

FIG. 4 illustrates a perspective view of a socket portion of the spud wrench.

FIG. 5 illustrates another perspective view of the socket portion of the spud wrench.

FIG. 8 illustrates a perspective view of a lever of the spud wrench.

FIG. 9 illustrates a close up view of the lever of FIG. 8.

FIG. 10 illustrates a perspective view of the top of an interchangeable insert of the invention.

FIG. 11 illustrates a top view of an interchangeable insert of the invention.

FIG. 12 illustrates a perspective view of the bottom of an interchangeable insert of the invention.

FIG. 13 illustrates another perspective view of the bottom of an interchangeable insert of the invention.

FIG. 14 illustrates another perspective view of the bottom of an interchangeable insert of the invention.

FIG. 15 illustrates a bottom view of an interchangeable insert of the invention.

FIG. 16 illustrates a perspective view of a spud wrench kit in a case.

FIG. 17 illustrates a perspective view of the components of the spud wrench kit.

### SUMMARY OF INVENTION

The present invention is directed to a spud wrench and a spud wrench kit. An embodiment of the present invention includes a spud wrench including a lever, a socket and an insert. The lever may include a first end and a second end, wherein the first end may be capable of imparting a force on the second end. The socket may include an aperture capable of receiving the lever within, wherein the socket may include an enlarged end. The insert may include an aperture in a first side and an opening in a second side, wherein the first end of the lever may be capable of insertion within the aperture of the first side. In addition, the socket may be capable of moving relative to the lever and the insert may be capable of moving relative to the socket.

Another embodiment of the present invention includes a spud wrench kit including a lever, at least one socket and at least one insert. The lever may include a first end and a second end, wherein the first end may be capable of imparting a force on the second end. The socket may include an enlarged end and a wrenching opening, wherein the wrenching opening may be capable of engaging a locking nut. The insert may be capable of being removably attached to the lever, wherein the inset may be capable of being positioned onto a fitting. The spud wrench kit may further include a socket wrench, a case and inserts of various shapes and sizes and sockets of various shapes and sizes. The inserts and the sockets may be interchangeably used with the lever in numerous manners.

### DETAILED DESCRIPTION

While the invention is described herein with reference to several embodiments, it should be clear that the invention should not be limited only to the embodiments disclosed or discussed. The description of the embodiments herein is illustrative of the invention and should not limit the scope of the invention as described or claimed.

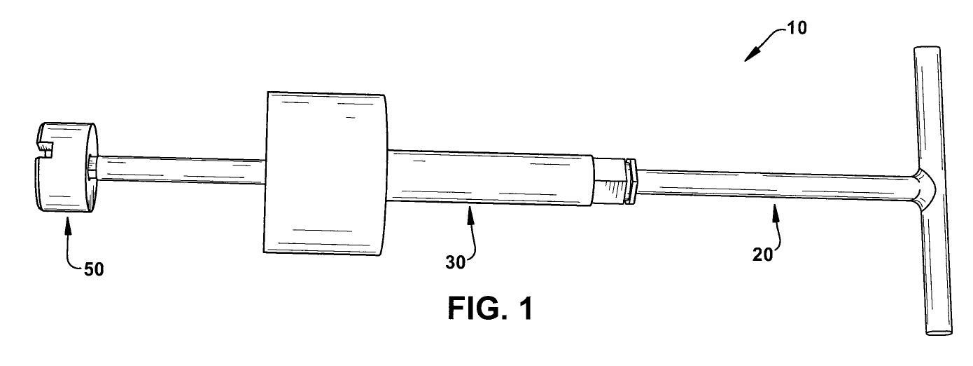

With reference to FIGS. 1-3, this invention provides an improved wrench apparatus 10 that may be used, for example, to assemble and disassemble the water inlet connection on urinals and commodes, commonly known as a spud (not shown). The wrench apparatus 10 may provide a single tool to accomplish the task usually performed by the combination of two or more tools.

The spud assembly (not shown) of a commode, for example, may include an externally threaded pipe or spud engaged with a locking nut and may have a flange at its end engaging the walls of the commode inlet, for example. The spuds have different shapes and sizes depending upon the application, brand name, origin and other factors. As a result, it is advantageous to provide a single wrenching apparatus 10 that may be used to remove differently sized spuds.

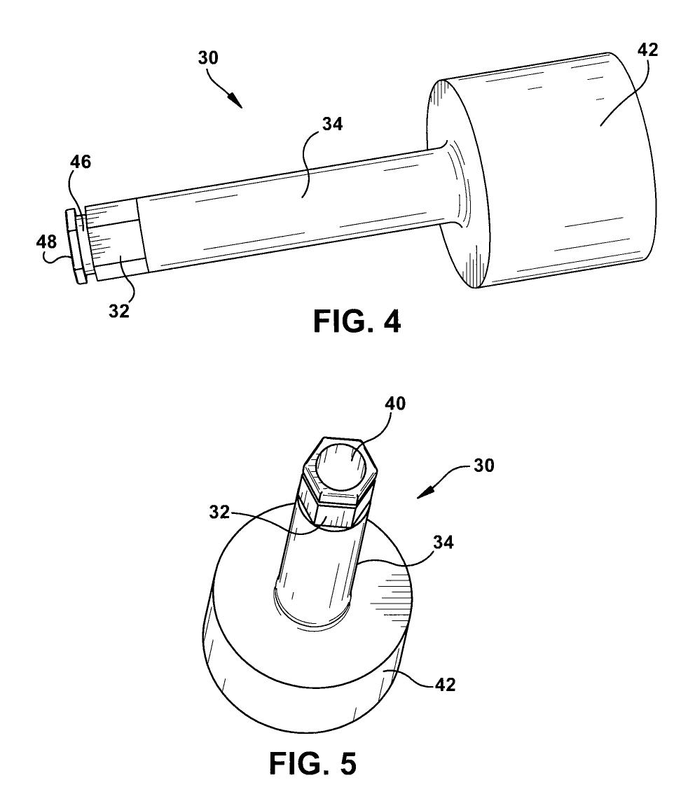

With further reference to FIG. 1, the spud wrench apparatus 10 may include a handle or lever 20, a socket portion 30 and a key or insert 50. With reference to FIGS. 4 and 5, the socket portion 30 may include a nut shaped end 32, a body portion 34, and an enlarged end 42. The socket 30 may include several different and separate pieces that may be assembled together, such as by fasteners, welding, adhesives, or the like, to form the socket 30. For example, the nut shaped end 32, body portion 34 and enlarged end 42 of the socket 30 may be separate pieces. Alternatively, the socket 30 may be of a one-piece construction, such as shown in FIGS. 4 and 5.

As best seen in FIGS. 4 and 5, the nut shaped end 32 of the socket 30 may include wrenching flats or any other appropriate type of configuration capable of imparting rotation on the socket 30. For example, the nut shaped end 32 may be sized and shaped to engage with a ratchet or wrench 76, whereby the ratchet or wrench 76 may impart force to rotate the socket 30.

The socket 30 may also include a groove 46 and a lip 48. The groove 46 may be located adjacent the nut shaped end 32. The lip 48 may be located adjacent the groove 46, as shown in FIG. 4. The groove 46 may permit a fastener, such as a cotter pin 72 or the like, to be placed within the groove 46 to maintain the wrench 76 in a certain position, which may be beneficial when assembling or disassembling a commode. The lip 48 then may aid in maintaining the fastener or cotter pin 72, for example, within the groove 46. Similar to the nut shaped end 32, the lip 48 may include wrenching flats or any other appropriate type of configuration capable of imparting rotation on the socket 30. For example, the lip 48 may be sized and shaped to engage with a ratchet or wrench 76, whereby the ratchet or wrench 76 may impart force to rotate the socket 30.

With reference to FIGS. 5-7, the socket 30 may be hollow or otherwise have a body opening 40 extending throughout and along the length of the socket 30. The body opening 40 may be of any appropriate shape or size, such as a shape and size that may be sufficient to slide onto or otherwise be positioned about the lever 20. The body opening 40 may also be of a differing or similar shape and size to that of the lever 20.

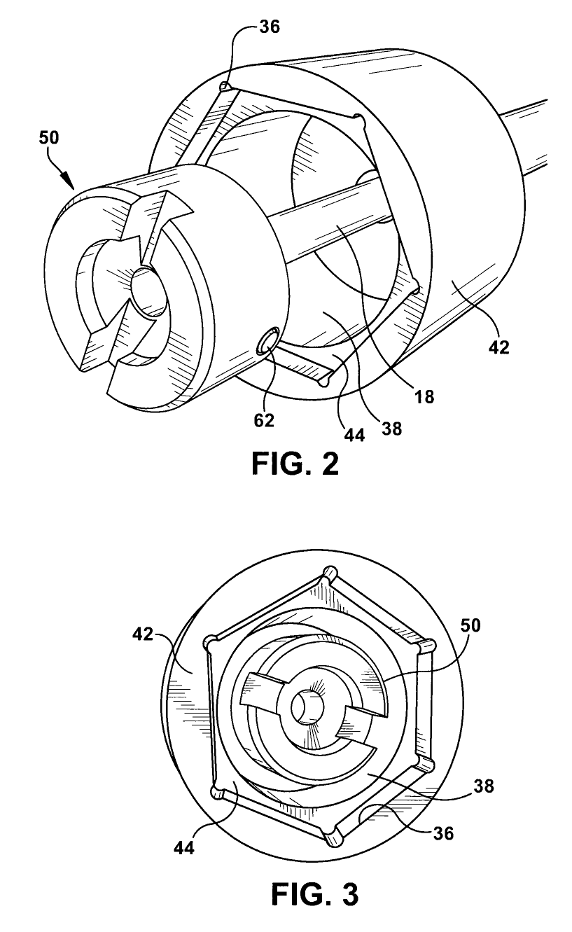

FIGS. 2, 3, 6 and 7 best illustrate the enlarged end 42 of the socket portion 30. The enlarged end 42 may include a wrenching or clamping portion for engaging a fitting or pipe. The enlarged end 42 may include a wrenching opening 36, an insert opening 38, and a face 44. As best shown in FIGS. 6 and 7, the wrenching opening 36 may be of any appropriate shape or size, such as any appropriate polygonal shape, hexagon, dodecagon, or the like, for example.

In an embodiment, the enlarged head 42 may have an interior shape and size corresponding to the shape and size of a predetermined fitting. For example, the enlarged head 42 may have a wrenching opening 36 for engaging a correspondingly shaped and sized fastener or fitting. Typically, modern fasteners, such as nuts and bolt heads, are made with hexagonal gripping surfaces and as such limit the number of positions a wrench may adopt when placed over them. Sockets are often produced in 6-point (hexagonal) and 12-point (double-hexagonal or dodecagonal) configurations.

When working in a confined area with limited turning space, 12-point sockets double the number of starting positions. On the other hand, 6-point sockets may offer a better grip on fittings and are less likely to slip and round off the corners with continued use and are generally preferred for damaged nuts and bolts.

With further reference to FIGS. 2, 3, 6 and 7, the insert opening 38 of the socket 30 may be located within the enlarged head 42. The insert opening 38 may be of any appropriate shape or size, such as a generally cylindrical shape. The insert opening 38 may be part of the wrenching opening 36 or may have a size and shape distinct from the wrenching opening 36. The insert opening 38 may be large enough to receive the insert 50 with the largest diameter or size. The insert opening 38 may also be of a differing or a correspondingly similar shape and size to that of the insert 50.

In an embodiment, the wrenching opening 36 may be larger in size than the round insert opening 38 and provide a face 44 for receiving the fitting or fastener (not shown). The face 44 may be of any appropriate shape or size. The face 44 may be positioned at any appropriate location within the enlarged end 42, such as adjacent to the wrenching opening 36. The wrenching opening 36 of the socket 30 may engage the locking nut of a spud assembly. The face 44 may prevent the fastener or locking nut from moving beyond the face 44 within the socket 30.

With reference to FIGS. 1, 8 and 9, the lever 20 may include a wrenching portion 16, a body portion 18, and an engaging end 24. The engaging end 24 may include a protrusion 26, which will be discussed in more detail below. The wrenching portion 16 and the engaging end 24 may be located at opposite ends, such that the engaging end 24 may be located at an end of the body portion 18 opposite that of the wrenching portion 16. The body portion 18 may be positioned at any appropriate location, such as between the wrenching portion 16 and the engaging end 24. The body portion 18 may also be of any appropriate shape, size, or length.

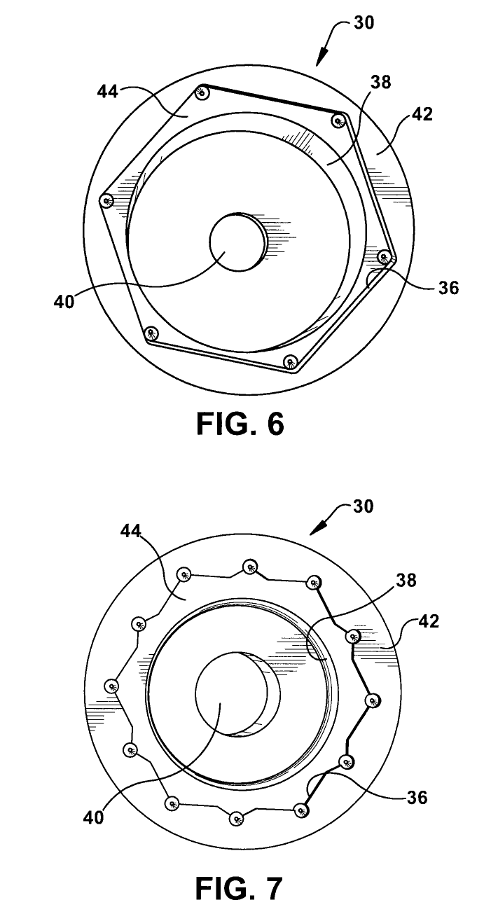

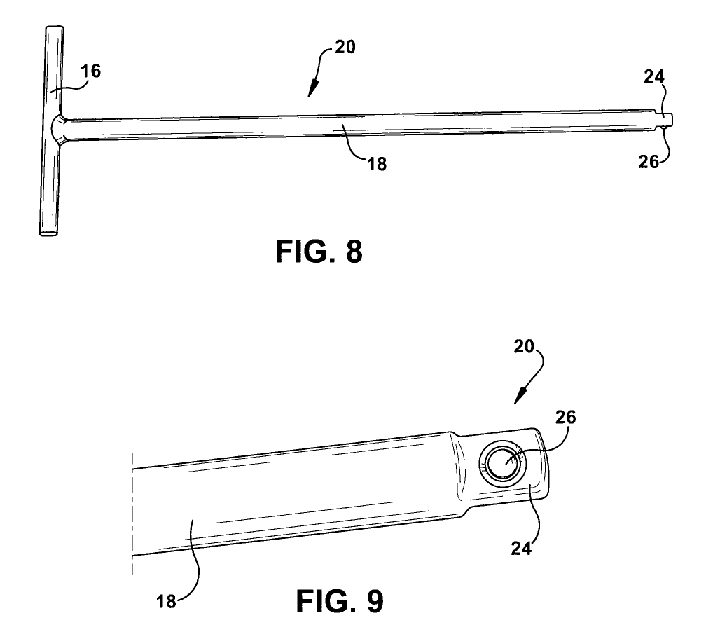

The lever 20 may be of any appropriate shape or size, such as in the shape of “T” or an “L”, for example. In an embodiment, the wrenching portion 16 may extend one direction from the body portion 18 to form the “L” shape. In another embodiment, the wrenching portion 16 may extend in two directions from the body portion 18 to from a “T” shape, as best shown in FIG. 8. The shape and configuration of the lever 20 should not be deemed as limited to any specific shape or configuration shown or described herein. One of ordinary skill in the art will appreciate that the wrenching portion 16 may be formed in numerous manners in order to ease the user in applying force, holding, or otherwise using the lever 20. When the lever 20 is engaged with the spud, the spud assembly may be prevented from rotation within, for example, an opening of a commode.

The lever 20 may also include a grip (not shown) on the wrenching portion 16 of the lever 20 to aid and/or to provide comfort for the user in applying force, moving, holding and otherwise manipulating the spud wrench apparatus 10. The grip may be attached to or otherwise secured to the wrenching portion 16 of the lever 20 by any appropriate means, such as by adhesives or the like. In an embodiment, the grip may be incorporated into the wrenching portion 16, such as in the form of groves, indentations or surface ridges that may permit a user to grasp the wrenching portion 16.

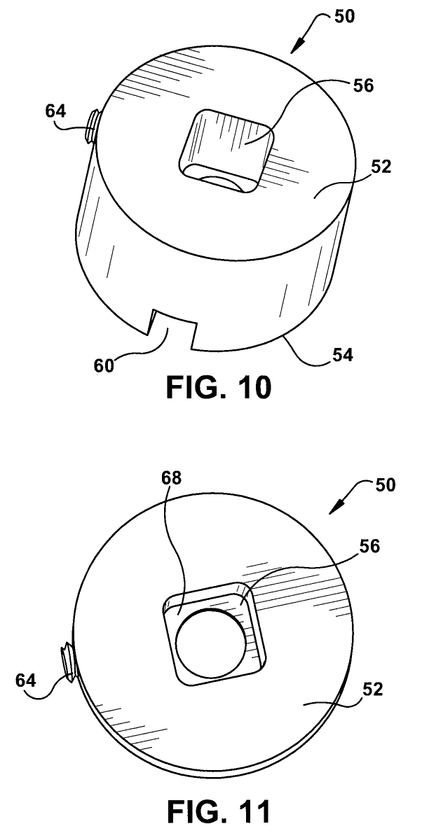

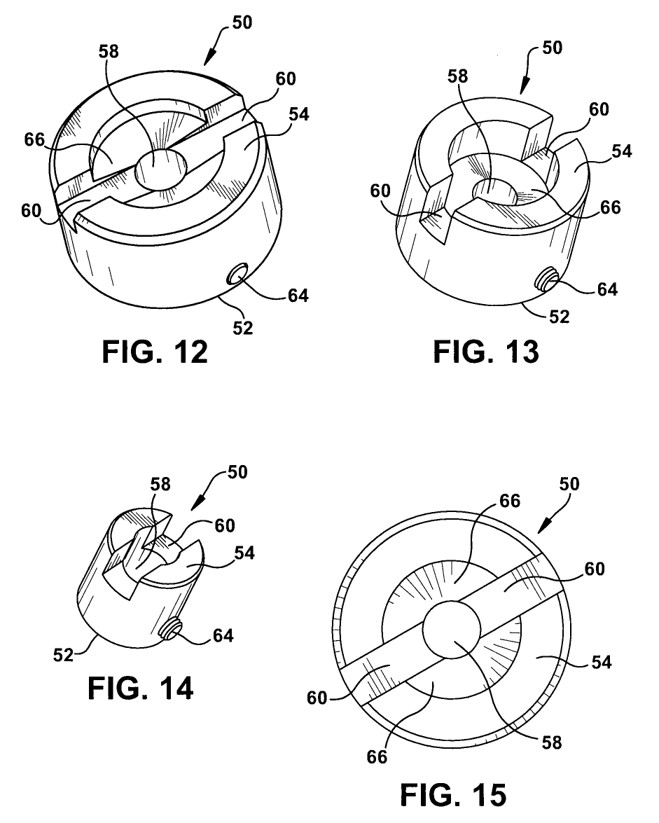

As shown in FIGS. 10-15, one or more inserts 50 may be used with and/or incorporated into the present invention. The inserts 50 may be of any appropriate shape or size. The inserts 50 may have different sizes, shapes, and diameters to correspond to varying sizes and shapes of a fitting or a pipe, such as a spud pipe. For example, the inserts 50 may be sized to correspond to standard sized spud pipes. As shown in FIGS. 10 and 12, the insert 50 may include a first face 52 and a second face 54. The insert 50 may have a thickness defined between the first face 52 and the second face 54. The thickness may be of any appropriate or desired size.

With further reference to FIGS. 10 and 11, the first face 52 of the insert 50 may include an aperture 56. The aperture 56 may be of any appropriate shape or size, such as a generally circular, triangular, rectangular shape, or the like, for example. The apertures 56 of the inserts 50 may correspond in size and shape with the engaging end 24 of the lever 20, such that the inserts 50 may be used with a single device, such as the lever 20 shown in FIG. 8.

In an embodiment, the insert 50 may include a face 68, as best shown in FIG. 11. The face 68 may receive the engaging end 24 of the lever 20. The face 68 may be of any appropriate shape or size. The face 68 may be positioned at any appropriate location within the insert 50, such as adjacent to the aperture 56. The aperture 56 of the insert 50 may engage the engaging insert 24. The face 68 may prevent the engaging end 24 of the lever 20 from moving beyond the face 68 within the insert 50.

As shown in FIGS. 12-15, the second face 54 may include an opening 58 and one or more slots 60. The slots 60 may be of any appropriate shape or size, such as a generally rectangular shape, for example. The slots 60 may be used to engage lugs of the spud, for example. The slots 60 may provide a groove or indentation, for example, that may mate with a portion of a fitting or a pipe, such as the lugs of a spud pipe. There may be any appropriate number of slots 60 having various sizes and shapes.

The lever 20 may be removably connectable to the inserts 50. The engaging end 24 of the lever 20, for example, may be removably attached to one of the inserts 50. The engaging end 24 may be removably attached to or connected to the aperture 56 of the inserts 50. The lever 20 and the inserts 50 may have a locking mechanism to prevent the insert 50 from undesirably separating from the lever 20.

With reference to FIGS. 2 and 10-14, the inserts 50 may include a detent 62. The detent 62 may extend through the side of the insert 50 to form a bore-like structure. The detent 62 may be of any appropriate shape or size, such as a generally cylindrical shape, for example. In such an embodiment, the spud wrench 10 may further include a pin 64 that may be insertable into the detent 62. The pin 64 may be of any appropriate shape or size, such as of a generally cylindrical shape. The pin 64 may also be of a generally similar shape to that of the detent 62. The pin 64 may be, for example, a bolt, a screw or the like. The pin 64 may have threads for engaging threads (not shown) within the detent 62. The pin 64 may be insertable into the exterior surface of the insert 50 and may be moved within the detent 62 to provide further resistance to separating the insert 50 from the lever 20.

In an embodiment, a locking mechanism of the spud wrench 10 may include a protrusion 26 located on the lever 20, such as the engaging end 24, and a detent 62 on the insert 50, as best shown in FIGS. 9-11. The protrusion 26 may be of any appropriate shape, size or configuration. For example, the protrusion 26 may be a frictional ball that may engage one or more of the inserts 50. The protrusion 26 may provide a removable “locking” type mechanism to removably secure and engage the inserts 50. The protrusion 26 may be spring biased or otherwise forced outward from the body of the lever 20. The protrusion 26 may also be movable into the body of the lever 20.

Once the engaging end 24 of the lever 20 is positioned on or within the aperture 56 of the insert 50, the protrusion 26 may provide for a friction fit between the lever 20 and the inserts 50. The friction fit may ensure that the inserts 50 may only be removed from the lever 20 when a predetermined amount of force is applied to separate the lever 20 from insert 50. The aperture 56 and the engaging end 24 of the lever 20 may correspond in size and shape.

As discussed above, the inserts 50 may have the detent 62 for matingly engaging the protrusion 26 of the lever 20. The detent 62 may correspond in size and shape to the protrusion 26. The pin 64 may be moved into the detent 62 to provide further resistance when attempting to separate the insert 50 from the lever 20. For example, the protrusion 26 may overcome the force of the pin 64 and the detent 62 before separating from the insert 50. In an embodiment, the pin 64 may be utilized to provide a permanent locking relationship between the lever 20 and insert 50. The mechanism for removably securing the inserts 50 to the lever 20 may be accomplished in many other manners and configurations as will be appreciated by one of ordinary skill in the art, and should not be limited to those shown and described herein.

The spud wrench 10 may be assembled in any appropriate manner, such as by positioning the socket wrench or ratchet 76 onto the nut shaped end 32 of the socket, then placing the socket 30 onto the lever 20. The insert 50 may then be slid onto or otherwise positioned onto the engaging end 24 of the lever 20. A fastener, such as a cotter pin 72, may be placed within the groove 46 thereby maintaining the socket wrench 76 at a stationary position on the socket 30.

In an embodiment, the socket 30 may be prevented from detachment from the lever 20 such that the socket 30 and the lever 20 may be inseparable, such as by fasteners, welding, or the like. For example, the engaging end 24 of the lever 20 may be positioned within the aperture 56 of the insert 50. The protrusion 26 of the lever 20 may retract as the insert 50 is positioned onto the lever 20 and extend (or rebound) to engaged the detent 62 of the insert 50. The engagement of the detent 62 and the protrusion 26 may provide for user feedback.

In use, the insert 50 may be positioned onto a fitting, such as a spud. The lever 20 may be held or otherwise used to prevent rotation of the insert 50 and the fitting. The wrenching opening 36 of the socket 30 may engage the locking nut, and a ratchet may be used to rotate the socket 30, such as via the nut shaped end 32, thereby rotating the locking nut while the pipe or fitting is prevented from rotation by the insert 50. The lever 20 may be held stationary by the one hand of the user while the user's other hand is free to ratchet the nut shaped end 32 of the socket 30.

In an embodiment, the ratcheting wrench 76 may be placed onto the body 18 of the lever 20, the sockets 30 of the spud wrench 10 may then be assembled onto the lever 20 for the appropriately sized spud for any particular application. The appropriately sized insert 50 may then be affixed to the engaging end 24 of the lever 20 and tightened by the set screw or pin 64. Once together this may provide a spud wrench assembly 10 for one sized spud. The individually sized inserts 50 and sockets 30 are what makes the spud wrench 10 work as a unit. Together this spud wrench apparatus 10 may accommodate all sized spuds used in the domestic market today.

For example, the apparatus 10 may be used on a standard spud assembly (not shown). A typical standard spud assembly consists of the spud itself, a rubber gasket sealing ring, a brass-retaining washer, and a locking nut, which is typical of a spud assembly normally used in connection with such commodes and urinals and other plumbing fixtures (not shown).

As known in the art, the toilet or commode includes a water inlet in one face thereof, the walls of which are upwardly convergent to facilitate the attachment of the spud thereto. In such an embodiment, the wrenching opening 36 of the socket 30 may engage the correspondingly shaped locking nut, whereby rotation of the ratchet in one direction will rotate the spud, for example. The wrenching thereby compressing the gasket of the spud assembly so as to withstand water pressures up to approximately 40 or 60 pounds per square inch.

As is also known in the art, the spud may be threaded at its upper end and have an outwardly flaring or conical flange at its lower end. The outer walls of the spud are parallel with the converging walls of the commode inlet and normally the conical flange is disposed within the commode inlet, but may be spaced there from in order to engage the correspondingly shaped conical flange of the rubber gasket sealing ring. The upper end of the gasket-sealing ring may be positioned upon the top of commode and has an annular flange of greater diameter than the inlet opening of the commode.

The washer may be positioned on the flange and the locking nut is threaded upon the headed portion of spud and squarely contacts and compresses the retaining washer and gasket-sealing ring to form a watertight connection between the converging walls of the commode inlet and the flange of the spud assembly. The completed connection of the spud assembly to the commode is such that the compression of the sealing ring may withstand approximately 40 to 60 pounds water pressure per square inch in order to effectively connect the spud assembly to the commode.

As is also known in the art, the spud may be a brass coupling that is used to connect a water supply tube (or down tube) to the china itself, it may be comprised of a flanged treaded brass nipple (which may have two nipples on the interior wall), a friction ring, and a spud nut. There are three different sizes of spuds which are universal throughout the plumbing industry. Those standard sizes are: 1½″ (closet), 1¼″ (urinal or closet) and ¾″ (urinal).

In an embodiment, each socket 30 may accommodate a correspondingly sized spud and spud nut. Each of the “keys” or inserts 50, which may be affixed to the lever 20, may allow the spud wrench 10 to grasp the two nipples in an effort to hold the bottom half of the spud stationary while utilizing a socket wrench 76 to ratchet the spud nut off of the top. The “keys” or inserts 50 may also made to accommodate each standard sized flanged threaded spud nipple. In addition, the inserts 50 may be manufactured out of any appropriate material, such as 12L14 cold rolled steel for example.

Movement of the ratchet while holding the lever 20 may tighten the locking nut of the spud assembly and secures the spud assembly to the commode. In addition, the flange of the rubber sealing ring may be forced against the top of the commode and the flange of the rubber sealing ring is sealed against the converging inlet walls of the commode so that the connection will withstand from approximately 40 to 60 pounds water pressure per square inch.

The wrench 10 therefore provides an effective and convenient tool for accomplishing the spud connection, and provides a wrench apparatus 10 in the form of a single tool, thus dispensing with the customary use of several tools to accomplish the same purpose. Moreover, the wrench 10 permits the plumber or user to operate in confined spaces while the wrench apparatus 10 prevents the spud from rotating while the locking nut is being threaded tightly onto the spud. The use of the wrench 10 permits the proper connection to be made in less time then using the usual separate conventional tools.

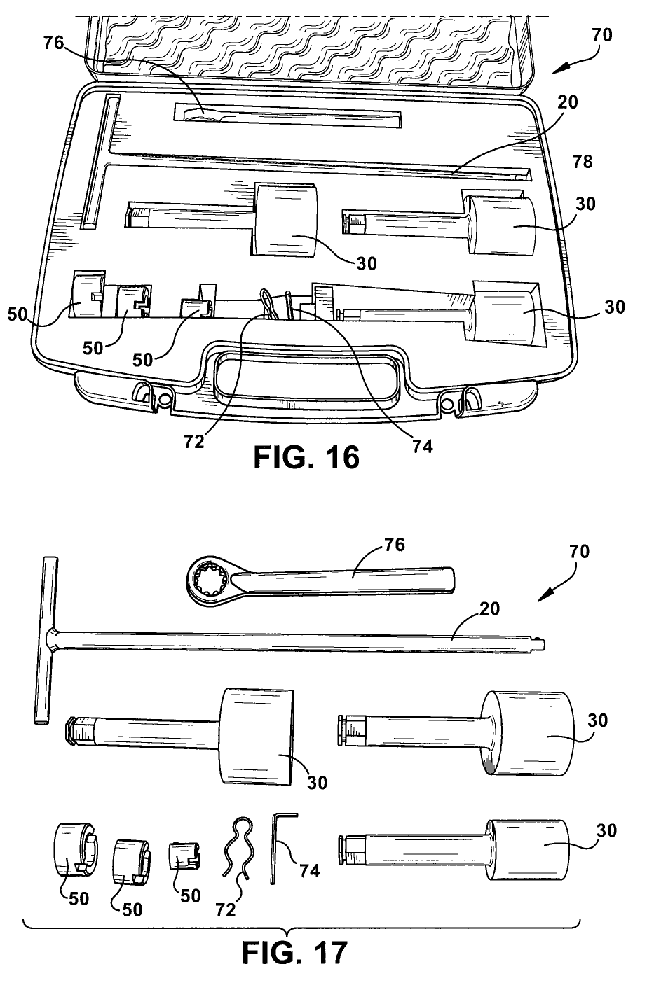

As illustrated in FIGS. 16 and 17, inserts 50 of various shapes and sizes may be provided in a set or a spud wrench kit 70 along with the lever 20 and sockets 30 of various shapes and sizes. As discussed above, the inserts 50 may be removably attached to the lever 20 depending on the size of the fitting or fastener in which the user desires to remove, attach, or otherwise manipulate. The inserts 50 may be pushed and/or otherwise positioned onto the engaging end 24 of the lever 20. The inserts 50 may be removed by pulling the insert 50 and/or the lever 20 to cause separation.

In an embodiment, the insert 50 may be positioned on the fitting, and the lever 20 may be pushed into the insert 50 while the insert 50 is engaged with the fitting. The inserts 50 may be interchangeably used with the lever 20 and sockets 30 in numerous manners as will be appreciated by one of ordinary skill in the art. The sockets 30 may also be interchangeably used with the lever 20 and inserts 50 in numerous manners as will be appreciated by one skilled in the art.

With further reference to FIGS. 16 and 17, the spud wrench kit 70 may include a lever 20, a variety of differently sized and shaped sockets 30, a variety of differently sized and shaped inserts 50, wrenches 74, 76, fasteners 72, and a case 78. The case 78 may provide for ease of transport and organization of the components of the spud wrench kit 70. The wrenches 74, 76 may be any appropriate type of wrench, such as an Allen wrench 74 and a socket wrench 76, for example. The Allen wrench 74 may be used to tighten or loosen the pin 64 into or out of the insert 50, for example. The fasteners 72 may be of any appropriate type of fasteners, such as a cotter pin 72, and the like, for example.

The embodiments of the invention have been described above and, obviously, modifications and alternations will occur to others upon reading and understanding this specification. The claims as follows are intended to include all modifications and alterations insofar as they come within the scope of the claims or the equivalent thereof.

Having thus described the invention, we claim:

1. A spud wrench comprising:
a lever having a first end and a second end, wherein said first end is capable of imparting a force on said second end;
a socket having an aperture capable of receiving said lever within, wherein said socket includes an enlarged end;
an insert having an aperture in a first side and an opening in a second side, wherein said first end of said lever is capable of insertion within said aperture of said first side;
wherein said socket is capable of moving relative to said lever; and
wherein said insert is capable of moving relative to said socket.

2. The spud wrench of claim 1, wherein said enlarged end includes an insert opening and a wrenching opening.

3. The spud wrench of claim 2, wherein said insert is capable of insertion within said insert opening of said socket.

4. The spud wrench of claim 2, wherein said wrenching opening is capable of engaging a locking nut.

5. The spud wrench of claim 4, wherein said insert is capable of being positioned onto a fitting.

6. The spud wrench of claim 5, wherein the fitting is a spud.

7. The spud wrench of claim 6, wherein said lever is capable of being pushed into said insert while said insert is engaged with the fitting.

8. The spud wrench of claim 7, wherein said lever is capable of preventing rotation of said insert and the fitting.

9. The spud wrench of claim 6, wherein said second side of said insert includes at least one slot.

10. The spud wrench of claim 9, wherein said slot is capable of engagement with a portion of the spud.

11. A spud wrench kit comprising:
a lever having a first end and a second end, wherein said first end is capable of imparting a force on said second end;
at least one socket having an enlarged end and a wrenching opening, wherein said wrenching opening is capable of engaging a locking nut; and
at least one insert capable of being removably attached to said lever, wherein said inset is capable of being positioned onto a fitting.

12. The spud wrench kit of claim 11, further including an Allen wrench to tighten or loosen a pin within said insert.

13. The spud wrench kit of claim 11, wherein the fitting is a spud.

14. The spud wrench kit of claim 13, wherein said lever is capable of being pushed into said insert while said insert is engaged with the fitting.

15. The spud wrench kit of claim 14, wherein said lever is capable of preventing rotation of said insert and the fitting.

16. The spud wrench kit of claim 11, further including a socket wrench for rotating said socket, thereby rotating the locking nut while the fitting is prevented from rotation by said insert.

17. The spud wrench kit of claim 16, further including a cotter pin for maintaining said socket wrench on said socket.

18. The spud wrench kit of claim 17, further including a case for ease of transport and organization of the components of the spud wrench kit.

19. The spud wrench kit of claim 18, wherein said inserts of various shapes and sizes and said sockets of various shapes and sizes are provided in said spud wrench kit with said lever.

20. The spud wrench kit of claim 11, wherein said inserts and said sockets are capable of being interchangeably used with said lever in numerous manners.
